(19) United States
(12) Patent Application Publication
(10) Pub. No.: US 2012/0051711 A1
(43) Pub. Date: Mar. 1, 2012

(54) VIDEO PLAYBACK DEVICE AND COMPUTER READABLE MEDIUM

(75) Inventor: Toshikazu KOMORIYA, Kanagawa (JP)

(73) Assignee: FUJI XEROX CO., LTD., Tokyo (JP)

(21) Appl. No.: 13/025,704

(22) Filed: Feb. 11, 2011

(30) Foreign Application Priority Data
Aug. 25, 2010 (JP) 2010-188032

(51) Int. Cl. H04N 5/935

(52) U.S. Cl. 386/201; 386/E05.002

(57) ABSTRACT

A non-transitory computer readable medium for playing back video includes: extracting a term from sound information contained in video information; reading material information having description relevant to the term based on the term extracted by the extracting; and combining video at a playback time of the sound information from which the term is extracted, of video displayed by playing back the video information and material displayed by the material information read by the reading.

### CROSS-REFERENCE TO RELATED APPLICATION

This application is based on and claims priority under 35 USC 119 from Japanese Patent Application No. 2010-188032 filed on Aug. 25, 2010.

### BACKGROUND

1. Technical Field

This invention relates to a video playback device and computer readable medium.

2. Related Art

An art of outputting material information relevant to the description of video information or sound information is proposed.

### SUMMARY

According to an aspect of the invention, a non-transitory computer readable medium for playing back video includes: extracting a term from sound information contained in video information; reading material information having description relevant to the term based on the term extracted by the extracting; and combining video at a playback time of the sound information from which the term is extracted, of video displayed by playing back the video information and material displayed by the material information read by the reading.

### BRIEF DESCRIPTION OF THE DRAWINGS

Exemplary embodiments of the invention will be described in detail based on the following figures, wherein:

FIG. 1 is a schematic drawing to show a configuration example of a video playback system according to a first exemplary embodiment of the invention;

FIG. 2 is a block diagram to show a configuration example of a video playback device;

FIG. 3 is a schematic drawing to show an example of a material management table stored in a material document DB;

FIG. 4 is a schematic drawing to show an example of the operation of the video playback device;

FIG. 5 is a schematic drawing to show a modified example of the operation of the video playback device;

FIG. 6 is a block diagram to show a configuration example of a video playback device according to a second exemplary embodiment of the invention;

FIG. 7 is a schematic drawing to show an example of personal material setting information stored in a storage section;

FIG. 8 is a schematic drawing to show an example of the operation of the video playback device;

FIG. 9 is a block diagram to show a configuration example of a video playback device according to a third exemplary embodiment of the invention; and

FIG. 10 is a schematic drawing to show an example of the operation of the video playback device.

### DETAILED DESCRIPTION

### First Exemplary Embodiment

### Configuration of Video Playback System

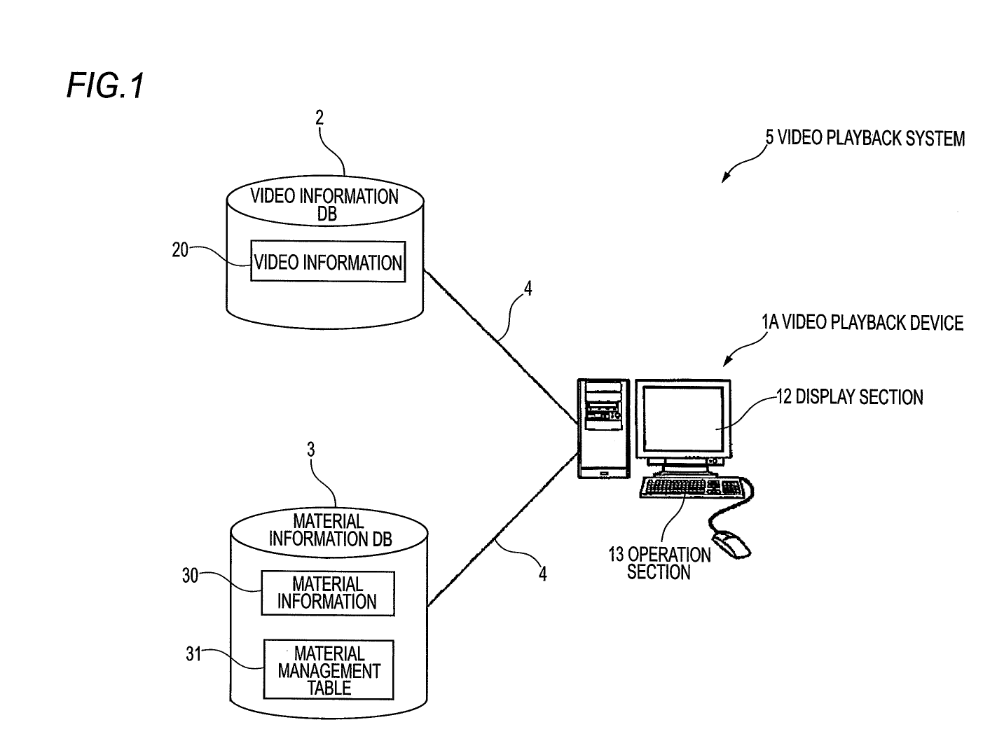

FIG. 1 is a schematic drawing to show a configuration example of a video playback system according to a first exemplary embodiment of the invention.

A video playback system 5 is made up of a video playback device 1A, a video information database server (DB) 2, and a material information DB 3 which are connected by a network 4 so that they may communicate with each other.

The video playback device 1A is an information processing device which includes electronic components of a CPU (Central Processing Unit) including an information processing function, a storage section, etc., and plays back video information 20 in the video information DB 2 and material information 30 in the material information DB 3. The video playback device 1A also includes a display section 12 of a liquid crystal display, etc., for displaying an image and an operation section 13 of a keyboard, a mouse, a touch pad, etc., for producing an operation signal responsive to operation. The video playback device 1A is, for example, a personal computer; in addition, a PDA (Personal Digital Assistant), a mobile telephone, etc., may also be used.

The video information DB 2 stores the video information 20 of moving image data in an MPEG (Moving Picture Experts Group) format, a VOB (Video Object) format, etc., for playing back video.

The material information DB 3 stores the material information 30 of image information in JPEG (Joint Photographic Experts Group), etc., document information in rich text, HTML (Hyper Text Markup Language), etc., and moving image data in MPEG VOB, etc., and a material management table 31 indicating attributes preset in the material information 30.

The network 4 is a communication network of a LAN (Local Area Network), the Internet, etc., and may be wired or may be wireless.

### Configuration of Video Playback Device

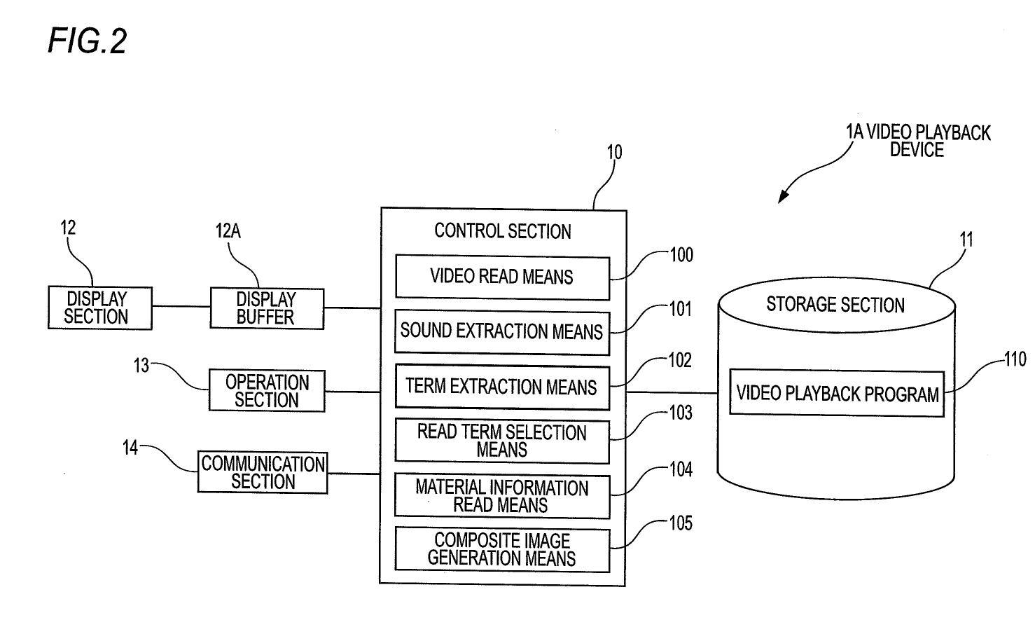

FIG. 2 is a block diagram to show a configuration example of the video playback device.

The video playback device 1A includes a control section 10 implemented as a CPU, etc., for controlling sections and executing various programs, a storage section of storage media of an HDD (Hard Disk Drive), flash memory, etc., for storing information, a display section 12 of a liquid crystal display, etc., for displaying a character and an image, and an operation section 13 of a keyboard, a mouse, etc., for producing an operation signal responsive to operation.

The video playback device 1A is an electronic device of a personal computer, a PDA, a mobile telephone, etc., for example, but may be a server or the like not including the display section. 12 or the operation section 13, in which case an operation section and a display section of a terminal device connected by a network, etc., replace the functions.

The control section 10 executes a video playback program 110 described later, thereby functioning as video read means 100, sound extraction means 101, term extraction means 102, read term selection means 103, material information read means 104, composite video generation means 105, etc.

The video read means 100 reads the video information 20 from the video information DB 2 every predetermined playback time in response to a video playback request of the user.

The sound extraction means 101 extracts sound information from the video information 20 at one playback time interval read by the video read means 100.

The term extraction means 102 converts the sound information read by the sound extraction means 101 into text information, etc., for example, and extracts terms of independent words, etc., from the text information.

The read term selection means 103 determines a condition based on the descriptions of information of the viewer using the video playback device 1A, the video information, etc., and selects the term matching the condition from the terms extracted by the word extraction means 102.

The material information read means 104 reads the material information 30 from the material DB 3 based on the term selected by the read term selection means 103 and the material management table 31.

The composite video generation means 105 combines the video information 20 read by the video read means 100 and the material document 30 read by the material information read means 104 to generate composite video and outputs the composite video to a display buffer 12A.

The storage section 11 stores the video playback program 110 for causing the control section 10 to operate as the means 100 to 105 described above.

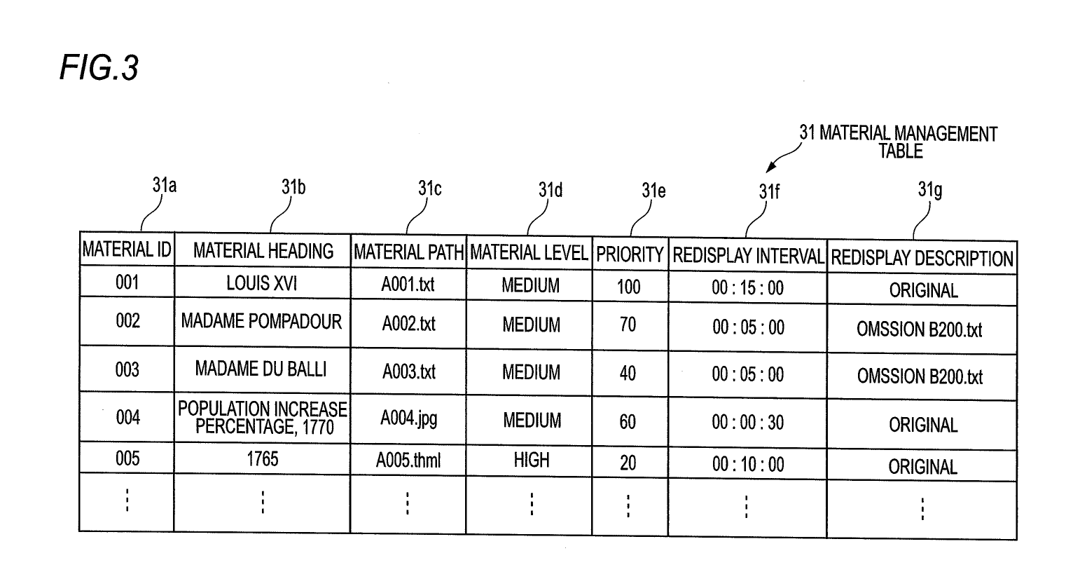

FIG. 3 is a schematic drawing to show an example of the material management table 31 stored in the material document DB 3.

The material management table 31 has a material ID column 31a indicating an identifier of the material information 30, a material heading column 31b indicating a term of a heading of the material information 30, a material path column 31c indicating the storage location of the material information 30, a material level column 31d indicating the level of difficulty, frequency, etc., set in the material information 30, a priority column 31e indicating display priority when plural of pieces of the material information 30 are read at the same time, a redisplay interval column 31f indicating the time interval of no display when the material information 30 is again read in the same video information 20, and a redisplay description column 31g indicating measures of omission or no omission, etc., for the description of the material information 30 when redisplay is produced.

### Operation of Video Playback Device of First Exemplary Embodiment

An operation example of the video playback device 1A will be discussed below as (1) basic operation, (2) material information read operation, and (3) playback operation with reference to FIGS. 1 to 5:

(1) Basic operation

First, a viewer operates the operation section 13 of the video playback device 1A and gives a playback command of the video information 20. The operation section 13 outputs an operation signal as a playback command of the video information 20 to the control section 10.

When the control section 10 of the video playback device 1A accepts the operation signal from the operation section 13, the video read means 100 reads the video information 20.

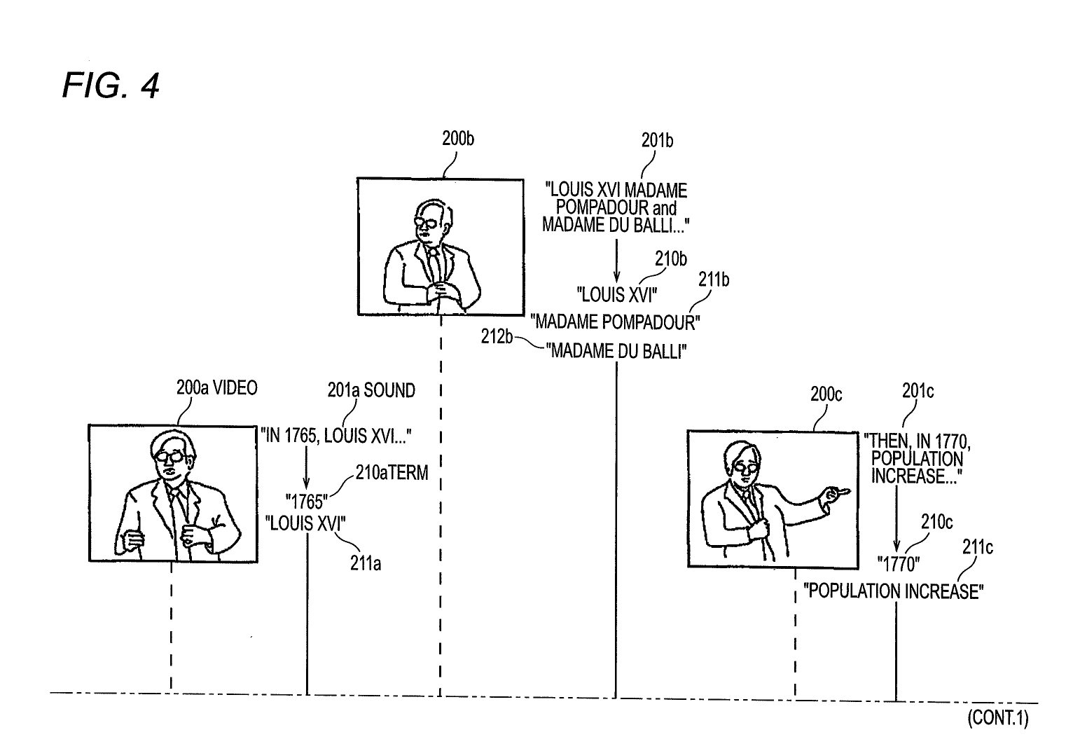

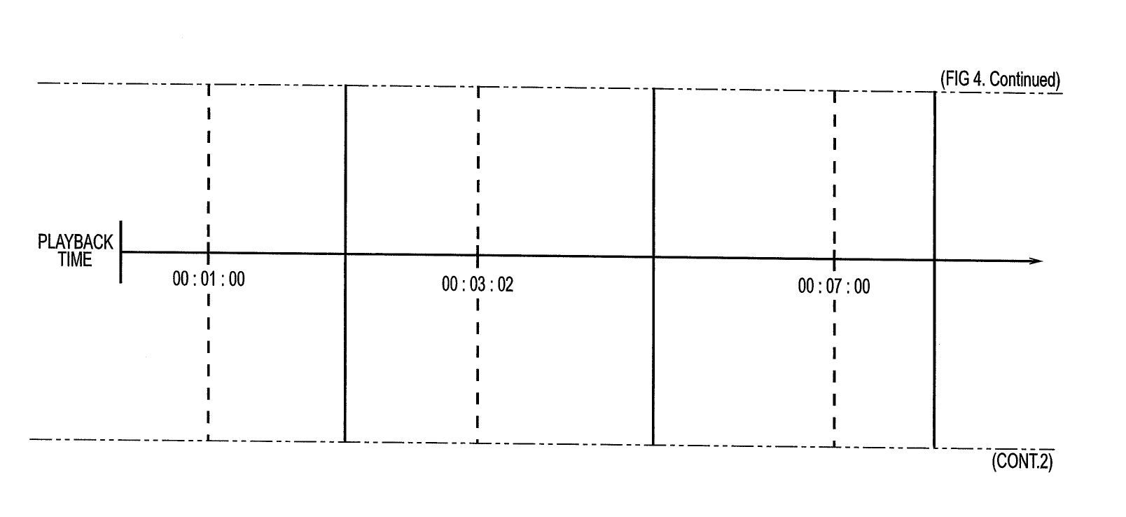

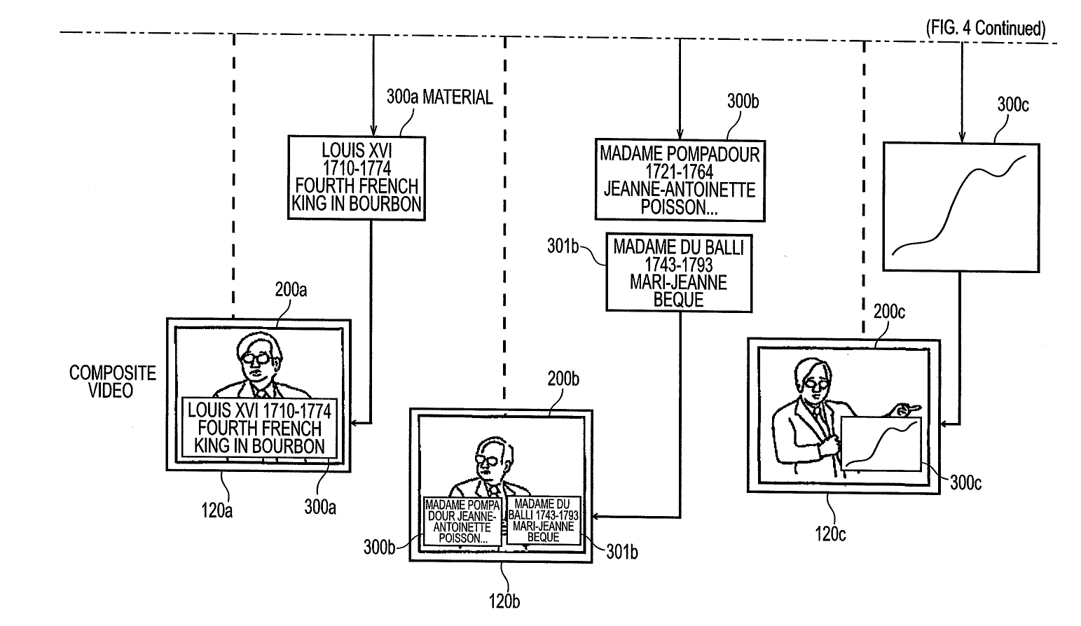

FIG. 4 is a schematic drawing to show an example of the operation of the video playback device 1A.

Video 200a, 200b, 200c . . . are video information read only at the interval of a predetermined playback time by the image read means 100 from playback times “00:01:00,” “00:03:02,” and “00:07:00” respectively.

The sound extraction means 101 reads sounds 201a, 201b, 201c . . . from the video 200a, 200b, and 200c read by the video read means 100.

Next, the term extraction means 102 converts sounds 201a, 201b, and 201c into text and extracts terms 210a and 211a of independent words from the sound 201a, terms 210b, 211b, and 212b from the sound 201b, and terms 210c and 211c from the sound 201c. The terms extracted by the term extraction means 102 are not limited to independent words and terms satisfying a predetermined condition by a designer or a viewer.

Next, the read term selection means 103 determines a condition based on the description of the video information 20, etc., for example, and selects the terms matching the condition from the terms 210a, 211a, 210b, 211b, and 212b extracted by the term extraction means 102. In the example shown in FIG. 4, the terms 211a, 210b, 211b, 212b, and 211c are selected and others are not selected. The terms are selected according to conditions such that “years are ignored” and that “nouns are selected.” The read term selection means 103 may select the terms according to other conditions predetermined by the designer or the viewer.

Next, since the term 211a selected by the read term selection means 103 matches “Louis XVI” under the material heading column 31b of the material management table 31 shown in FIG. 3, the material information read means 104 reads material 300a stored in path “A001.txt” indicated under the material path column 31c from the material information DB 3.

Although the terms 210b, 211b, and 212b selected by the read term selection means 103 match the material heading column 31b of the material management table 31, as for the term 210b of “Louis XVI,” the redisplay interval column 31f is “00:15:00” and thus the playback time of the material 300a previously displayed is “00:01:00” and a condition of “within 15 minutes” is not satisfied and the material information read means 104 does not read the material. The material information read means 104 reads materials 300b and 301b based on the terms 211b and 212b.

Since the term 211c selected by the read term selection means 103 matches “population increase” under the material heading column 31b of the material management table 31, the material information read means 104 reads material 300c stored in path “A004.jpg” shown under the material path column 31c from the material information DB 3.

The materials 300a, 300b, 301b, and 300c described above are displayed preferentially in the descending order of the numeric values under the priority column 31e of the material management table 31. The material redisplayed and satisfying the condition under the redisplay interval column 31f is again displayed if the redisplay description column 31g is “original;” if “omission” is described, material information of omission version in the path written side by side is read and is displayed.

Next, the composite video generation means 105 combines the video 200a and the material 300a, the video 200b and the materials 300b and 301b, the video 200c and the material 300c to generate composite images 120a, 120b, 120c . . . and outputs them to the display buffer 12A.

(2) Material information read operation described above is repeated every a predetermined time about the playback time of the video information, for example, every three to 10 seconds. Sound information may be early extracted and the video information 20 may be read for each silent portion where a sound discontinues.

(3) Playback operation

When composite video as much as a predetermined time is stored in the display buffer 12A, the composite video is displayed on the display section 12.

### Modified Example

When plural of terms are selected within a predetermined time for executing (2) material information read operation and the materials corresponding to the terms may not be displayed at a time in a composite image, for example, the composite video generation means 105 operates as follows:

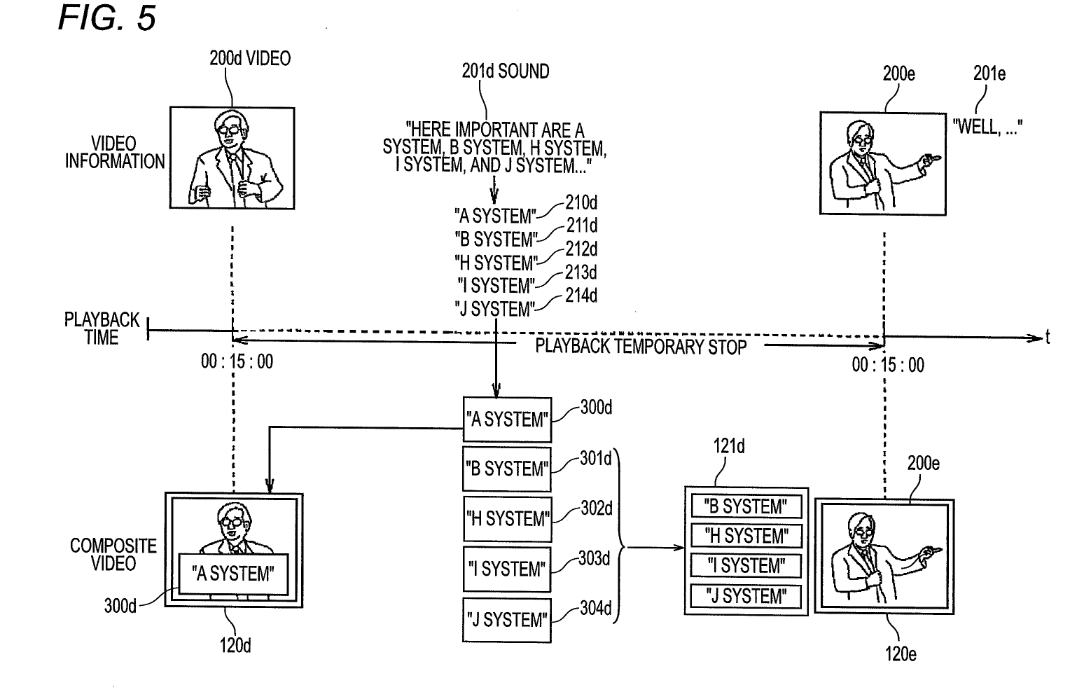

FIG. 5 is a schematic drawing to show a modified example of the operation of the video playback device 1A.

If terms 210d to 214d are extracted by the term extraction means 102 from a sound 201d extracted by the sound extraction means 101 and all terms are selected by the read term selection means 103, the material information read means 104 reads materials 300d to 304d.

If the composite video generation means 105 determines that all of the materials 300d to 304d may not be combined with video 200d at a time, for example, a predetermined number or more of materials are read, the composite video generation means 105 combines any number equal to or less than the number of materials that may be combined, for example, one material 300d is combined with the video 200d to generate a composite image 120d, and only the remaining materials 301d to 304d are combined to generate a composite image 121d.

The composite images 120d and 121d are output to the display buffer 12A and are played back and are displayed on the display section 12. Playback of video 200 is temporarily stopped during display of the composite image 121d and the composite image 121d is displayed for a predetermined time and then playback is again executed at the video next to the video 200d.

The video information 20 may be temporarily stopped and the composite image 121d containing the read materials 301d to 304d may be displayed not only at the timing at which material information 30 that may not completely be displayed is read, but also at good separation timing of the video information 20, for example, at the timing at which a sound discontinues, at the scene change timing of video, etc. However, the video is displayed within a predetermined time from the read timing of the material information 30.

If time during which no term is extracted exists in video after the video 200e, the materials 301d to 304d may be combined in sequence together with the video after the video 200e without temporarily stopping playback of the video 200d.

### Second Exemplary Embodiment

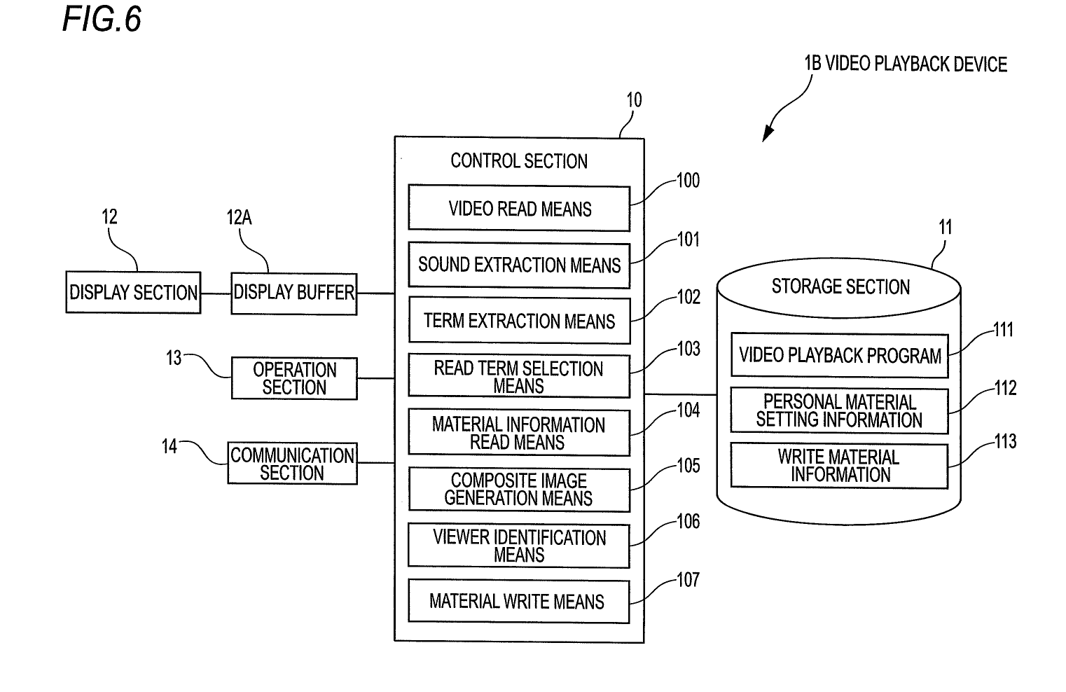

FIG. 6 is a block diagram to show a configuration example of a video playback device according to a second exemplary embodiment of the invention. The second exemplary embodiment differs from the first exemplary embodiment in that a viewer viewing video information 20 is identified and that a viewer may write. The different configuration from that of the video playback device 1A of the first exemplary embodiment will be discussed below:

A control section 10 of a video playback device 1B executes a video playback program 111, thereby viewer identification means 106 and material write means 107 in addition to means 100 to 105.

The viewer identification means 106 requests a viewer viewing video in the video playback device 1B to enter information of a viewer ID, a password, etc., for example, and identifies the viewer in response to the entries.

The material write means 107 stores the description written by the viewer in a memo write area displayed together with a composite image in a storage section 11 as write material information 113 described later.

The storage section stores the video playback program 111 for causing the control section 10 to function as the means 100 to 107, personal material setting information 112 in which a condition when material information read means 104 reads a material, write material information 113 generated by the material write means 107 based on write of the viewer, and the like.

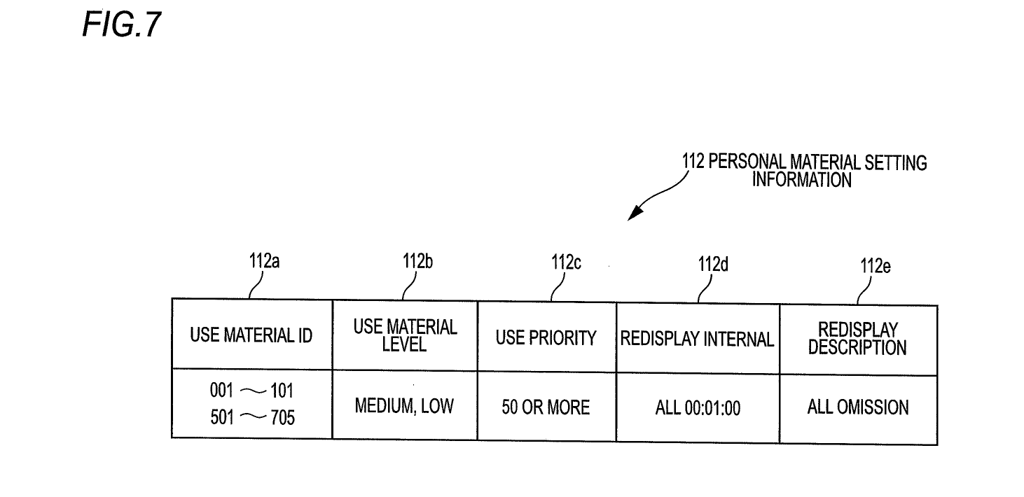

FIG. 7 is a schematic drawing to show an example of the personal material setting information 112 stored in the storage section 11.

The personal material setting information 112 is information provided for each viewer using the video playback device 1B and has a use material ID column 112a indicating the identifier of material read by the material information read means 104, a use material level column 112b indicating the level of used material corresponding to the material level column 31d of the material management table 31 shown in FIG. 3, a use priority column 112c indicating a threshold value of priority of used material corresponding to the priority column 31e of the material management table 31, a redisplay interval column 112d forcibly set in place of the value under the redisplay interval column 31 f of the material management table 31, and a redisplay description column 112e forcibly set in place of the value of the redisplay description column 31g of the material management table 31.

### Operation of Video Playback Device of Second Exemplary Embodiment

First, the viewer identification means 106 requests a viewer viewing video to enter a viewer ID, a password, etc., and identifies the viewer. Then, the material information read means 104 references the personal material setting information 112 corresponding to the identified viewer.

In the second exemplary embodiment, when reading the material information 30 in (2) material information read operation, the material information read means 104 reads the material information 30 based on the descriptions of the columns 112a to 112e of the personal material setting information 112.

In the example shown in FIG. 7, the material information read means 104 reads only the materials whose IDs are “001-101 and 501-705” in accordance with the description of the use material ID column 112a and do not read materials having other IDs. Only the materials set to “medium” or “low” in the material level column 31d of the material management table 31 in accordance with the use material level column 112b are used and the material having “005” in the material ID column 31a is not used. Only the materials set to “50” or more in the priority column 31e of the material management table 31 based on the use priority column 112c are used and the material having “005” in the material ID column 31a is not used.

The description of the redisplay interval column 112d is forcibly set in place of the value of the redisplay interval column 31f of the material management table 31, and the redisplay interval is all set to “00:01:00.” The description of the redisplay description column 112e is forcibly set in place of the value of the redisplay description column 31g of the material management table 31, and material for omission is all used as the display description. If material for omission does not exist, an original is used.

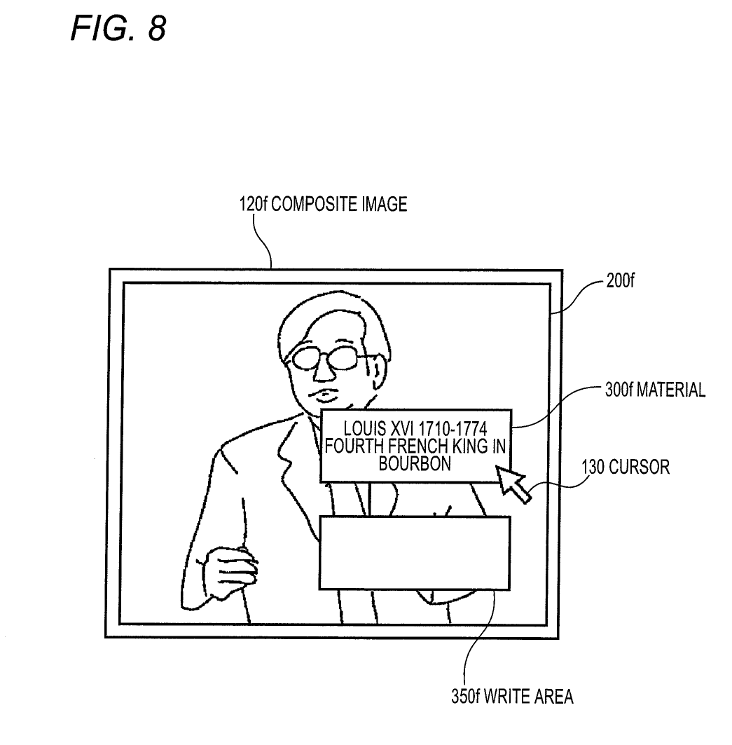

FIG. 8 is a schematic drawing to show an example of the operation of the video playback device.

Composite video 120f displayed on the display section 12 has video 200f, a material 300f read from sound information of the video 200f, a write area 350f for writing a character, etc., in response to an operation signal output by the operation section 13, and a cursor 130 for executing a move and determination in response to an operation signal output by the operation section 13.

The material write means 107 displays the write area 350f in the composite image 120f, generates the description written into the write area 350f in response to an operation signal output by the operation section 13 as the write material information 113 in association with the viewer identified by the viewer identification means 106, and stores the information in the storage section.

The material write means 107 may record the material 300f pointed to and selected by the cursor 130 in association with the written description of the write material information 113 and the playback time of the video information 20.

### Third Exemplary Embodiment

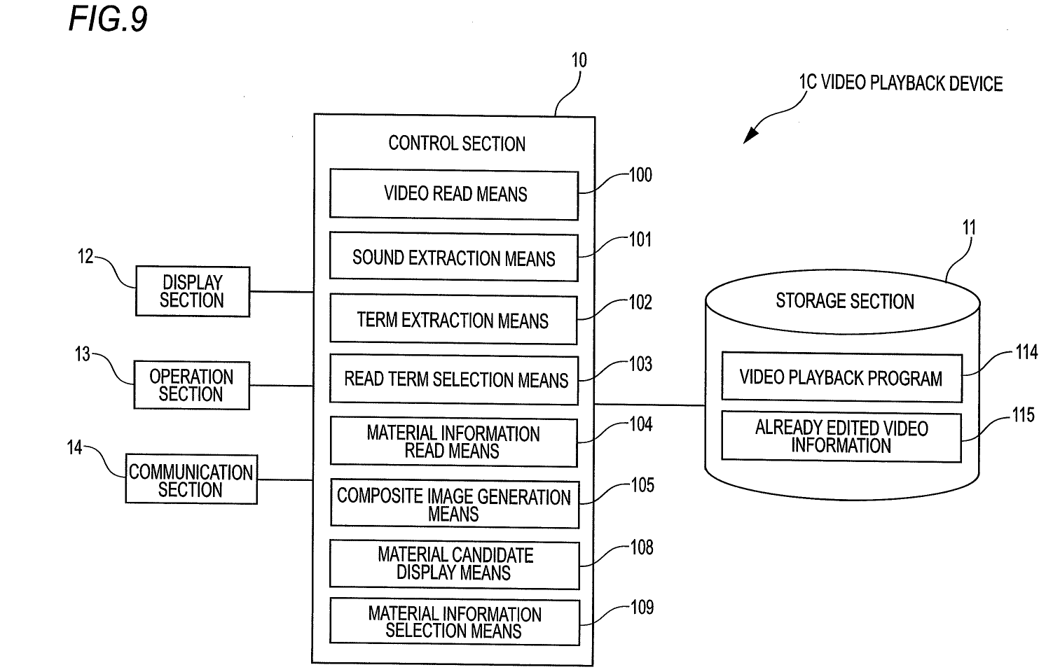

FIG. 9 is a block diagram to show a configuration example of a video playback device according to a third exemplary embodiment of the invention. The third exemplary embodiment differs from the first exemplary embodiment in that a viewer may select a material to be displayed from material information read by material information read means 104 and that composite video provided by combining document information 30 with video information 20 is generated as already edited video information and is stored in a storage section 11 without directly displaying it on a display section 12.

A control section 10 of a video playback device 1C executes a video playback program 114, thereby functioning as material candidate display means 108 and material information selection means 109 in addition to means 100 to 105.

The material candidate display means 108 displays plural of materials read by the material information read means 104 on a candidate display screen described later as candidates for the material to be displayed.

The material information selection means 109 selects used material information from the material information on the candidate display screen displayed by the material candidate display means 108 in response to an operation signal output by the operation section 13.

The storage section stores the video playback program 114 for causing the control section 10 to operate as the means 100 to 105, 108, and 109, the already edited video information 115 containing the composite video generated by combining the material selected by the material information selection means 109 and video by the composite video generation means 105, and the like.

### Operation of Video Playback Device of Third Exemplary Embodiment

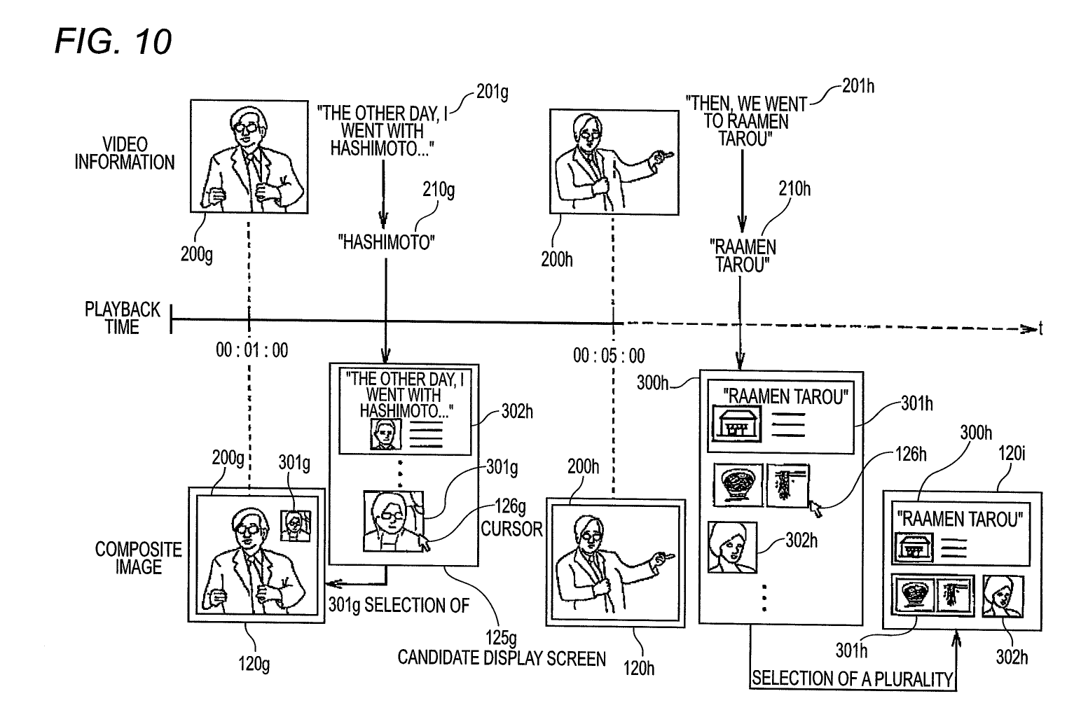

FIG. 10 is a schematic drawing to show an example of the operation of the video playback device 1C.

Video 200g and video 200h are video whose playback time is “00:01:00” and video whose playback time is “00:05:00” and are shown as representatives of the description of video information 20 read by the video read means 100.

The voice extraction means 101 reads sounds 201g, 201h . . . from video information 20 at the same time as the video read means 100 reads the video 200g, 200h . . .

Next, the term extraction means converts the sounds 201g, 201h . . . into text and extracts a term 210g from the sound 201g and a term 210h from the sound 201h, for example.

Next, the material information read means 104 reads all of materials 300g to 301g and materials 300h to 301h matching the terms 210g and 210h from a material heading column 31b of a material management table 31 from a document information DB 3 by referencing paths indicated under the material path column 31c.

Next, the material candidate display means 108 displays the materials 300g to 301g and the materials 300h to 301h read by the material information read means 104 on candidate display screens 125g and 125h.

Next, the material information selection means 109 moves cursor 125g and 125h based on an operation signal output by the operation section 13 from candidate display screens 125g and 125h displayed by the material candidate display means 108 and outputs materials selected by the cursor 125g and 125h to the composite video generation means 105. In the example shown in FIG. 10, material 301g is selected on the candidate display screen 125g and materials 300h, 301h, and 302h are selected on the candidate display screen 125h.

Next, the composite video generation means 105 combines the video 200g and the material 301g to generate composite video 120g, adopts the video 200h solely as composite video 120h, generates composite video 120i from the materials 300h, 301h, and 302h, and performs similar processing about all video to generate the already edited video information 115.

In the exemplary embodiment, the material information 30 is not limited to an image, video, or a document of HTML, etc., and may be image correction processing to the video 200g, 200h . . . , video effect concatenating scene changes of video, etc., for example.

### Other Exemplary Embodiments

The invention is not limited to the exemplary embodiments described above and various modifications are possible without departing from the scope and the spirit of the invention. For example, material information may be read from information of only sound information not involving video according to the invention and may be displayed on the display section in synchronization with playback of the sound information.

The video playback programs 110, 111, and 114 may also be stored in a storage medium of a CD-ROM, etc., and may be provided or may be downloaded into the storage section in the device from a server, etc., connected to a network of the Internet, etc. Some or all of the video read means 100, the sound extraction means 101, the term extraction means 102, the read term selection means 103, the material information read means 104, the composite video generation means 105, the viewer identification means 106, the material write means 107, the material candidate display means 108, and the material information selection means 109 may be implemented as hardware of an ASIC, etc. The order of the steps shown in the operation description of the exemplary embodiments may be changed and the steps may be omitted or added.

What is claimed is:

1. A non-transitory computer readable medium storing a computer readable program executable by a computer for causing a computer to execute a process for playing back video, the process comprising:
extracting a term from sound information contained in video information;
reading material information having description relevant to the term based on the term extracted by the extracting; and
combining video at a playback time of the sound information from which the term is extracted, of video displayed by playing back the video information and material displayed by the material information read by the reading.

2. The computer readable medium according to claim 1 wherein the reading reads the material information if information associated with the material information satisfies a predetermined condition.

3. The computer readable medium according to claim 2 for further comprising:
identifying a viewer viewing the video information, wherein
the reading reads material information satisfying a predetermined condition for each identified viewer.

4. The computer readable medium according to claim 1 wherein if the number of pieces of material information read by the reading exceeds a predetermined number during a predetermined time about the playback time of the video information, the combining temporarily stops playback of the video information until display of the read material information is complete.

5. The computer readable medium according to claim 1 further comprising:
displaying the material information read by the reading as material candidates; and
selecting material information to be used from the material candidates displayed by the displaying in response to a request of a viewer.

6. A video playback device comprising:
a term extraction unit that extracts a term from sound information contained in video information;
a read unit that reads material information having description relevant to the term based on the term extracted by the term extraction unit; and
a combining unit that combines video at a playback time of the sound information from which the term is extracted, of video displayed by playing back the video information and material displayed by the material information read by the read unit.

7. The video playback device according to claim 6 wherein the read unit reads the material information if information associated with the material information satisfies a predetermined condition.

8. The video playback device according to claim 7 further comprising:
an identification unit that identifies a viewer viewing the video information, wherein
the read unit reads material information satisfying a predetermined condition for each identified viewer.

9. The video playback device according to claim 6 wherein if the number of pieces of material information read by the read unit exceeds a predetermined number during a predetermined time about the playback time of the video information, the combining unit temporarily stops playback of the video information until display of the read material information is complete.

10. The video playback device according to claim 6 for further causing the computer as:
a material candidate display unit that displays the material information read by the read unit as material candidates; and
a selection unit that selects material information to be used from the material candidates displayed by the material candidate display unit in response to a request of a viewer.
